(19) United States
(12) Patent Application Publication
(10) Pub. No.: US 2014/0061108 A1
(43) Pub. Date: Mar. 6, 2014

(54) PORTABLE WATER CONTAINER WITH PUMP AND FILTER

(71) Applicant: SimpliPure, Inc., Newport Beach, CA (US)

(72) Inventor: Tareq Adel RIsheq, Laguna Niguel, CA (US)

(73) Assignee: SimpliPure, Inc., Newport Beach, CA (US)

(21) Appl. No.: 14/010,346

(22) Filed: Aug. 26, 2013

Related U.S. Application Data
(60) Provisional application No. 61/693,141, filed on Aug. 24, 2012.
(60) Provisional application No. 61/780,304, filed on Mar. 13, 2013.

(51) Int. Cl. B01D 35/02

(52) U.S. Cl. CPC B01D 35/02
USPC 210/136

(57) ABSTRACT

A portable water delivery system is described. The system includes a container with an opening, and a filtration system disposed in the opening. The filtration system has two chambers connected by a one-way valve conduit. A pump is disposed in the first chamber and a filter cartridge is disposed in the second chamber. As the pump is pulled upward, water is drawn from the container into the first chamber via a one-way valve inlet. As the pump is pushed downward, water is pushed from the first chamber to the second chamber via the one-way valve conduit and out the spout of the container.

This application claims priority to U.S. Provisional Patent Application Ser. No. 61/693141 filed on Aug. 24, 2012 and U.S. Provisional Patent Application Ser. No. 61/780304 filed on Mar. 13, 2013, which are incorporated herein by reference.

### FIELD OF THE INVENTION

The field of the invention is containers, more specifically, containers with pump and filter systems for water treatment.

### BACKGROUND

The following background discussion includes information that may be useful in understanding the present invention. It is not an admission that any of the information provided herein is prior art or relevant to the presently claimed invention, or that any publication specifically or implicitly referenced is prior art.

Drinking water contamination is still a significant concern in many parts of the world. Drinking water contaminants can include pathogens (bacterium, virus, microorganisms, etc.), heavy metals, pesticides, industrial by-products (solvents, refrigerants, etc), and toxic chemicals, to name a few. These contaminants are a major cause of death in many under-developed countries and still pose significant health risks in developed countries. There is a tremendous need for cost efficient solutions to the problem of drinking water contamination.

Noah Water Systems (see http://www.noahwater.com.) provides various portable filtration systems for emergency responders during natural disasters. The Trekker™ product, for example, is capable of producing 1 gallon (3.8 liters) of safe drinking water per minute, and is small and light enough to be carried by hand into remote locations. Unfortunately, Trekker™ costs over $1,000 US dollars and requires electrical power to operate. In addition, the filtration system does not include containers for storing water.

Various portable water delivery systems are known. For example, the Hydroller™, made by Reliance Products, LP (see http://www.relianceproducts.com/), is an 8 gallon portable water container that has wheels and a handle. Another example of portable water delivery systems can found at http://www.wizardkicking.com/hydration-systems.html. Unfortunately, these portable water delivery systems do not have a built-in filtration system for purifying water.

US Patent Application Publication No. 2010/0187183 to Nelson describes a portable water bottle with a filter and a pump. The pump provides sufficient pressure to force water through the filter and out of the water bottle for drinking. Unfortunately, the water bottle in Nelson is too small to provide safe drinking water for large groups of people.

UK Patent Application No. GB2473256 to Pritchard discloses a 20 liter (5.28 US gallons) portable jerrycan that has an active carbon filter and a piston pump for forcing water through the filter. As such, Pritchard provides a portable water filter container for delivering significantly large amounts of filtered water. Unfortunately, the jerrycan in Pritchard is pressurized when the pump is actuated, which can weaken the jerrycan over time and causes inconsistent dispensing flow rates.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, while some portable water containers having filtration systems are generally known, the current state of the art fails to provide a portable filter-container that is hand-powered, easy to use, safe, cost-effective, and easy to transport over long distances.

Thus, there is still a need for improved portable water containers and filtration systems for delivering large quantities of filtered drinking water.

### SUMMARY OF THE INVENTION

The inventive subject matter provides apparatus, systems and methods in which a filtration system comprises a housing with two chambers connected by a one-way valve conduit. The first chamber includes a pump and the second chamber includes a filter. The first chamber is sealed from the surrounding environment (e.g., atmosphere and/or lumen of a water container) such that a pressure decrease is created in the first chamber when the pump is actuated (e.g., pulled). This pressure difference draws liquid into the first chamber through a one way valve inlet. When the pump is further actuated (e.g., pushed), the water is pushed from the first chamber into the second chamber via the one-way valve conduit, through a filter in the second chamber, and out of the filtration system for drinking. Another one-way valve in the inlet prevents water from exiting the inlet when the pump is actuated.

The filtration system can be used in combination with a container. The filtration system's housing has a flange that is sized and dimensioned to mate with an opening of a container. In some embodiments, the flange includes threads that mate with threads on the container's opening. The filter system serves as a cap for the container. The container can be filled with water or any other liquid by removing the filtration system to access the container's opening.

The container can include a handle and wheels, to allow for easy transportation. The container can also include one or more brace members that connect different walls of the container to provide additional strength. The container can also include a spout for dispensing the water.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a perspective view of one embodiment of a portable liquid delivery system that has a pump and filter.

FIG. 2 is a back-perspective view of the delivery system of FIG. 1.

FIG. 3 is a cross sectional view of the delivery system of FIG. 1, showing the internal components of the container and the filter system.

FIG. 4 is a cross sectional view of the filtration system inside the delivery system FIG. 1.

FIG. 5 is a cross sectional view of the filtration system of FIG. 4, showing the pathway of fluid flow.

FIG. 6 is a top-perspective cross sectional view of the filtration system of FIG. 4.

FIG. 7 is perspective view of an alternative embodiment of a portable liquid delivery system.

FIG. 8 is a side view of the delivery system of FIG. 7.

FIG. 9 is a front view of the delivery system of FIG. 7.

FIG. 10 is a cross-sectional side perspective view of the delivery system of FIG. 7, illustrating a first chamber of the filtration system.

FIG. 11 is a cross-sectional side perspective view of the filter system of FIG. 7, illustrating a second chamber of the filtration system.

FIG. 12 is a close-up cross sectional view of the first chamber of FIG. 10.

FIG. 13 is a close-up view of the one-way valve conduit of FIG. 12.

FIG. 14 is an exploded view of the filtration system in the delivery system of FIG. 7.

FIG. 15 is a close-up perspective view of the top of the filtration system coupled with the delivery system of FIG. 7.

FIG. 16 is a close-up cross sectional view of the filtration system and delivery system of FIG. 7.

FIG. 17 is various views of a cap coupled with the delivery system of FIG. 7.

FIG. 18 is a side view of portable liquid delivery system with wheels.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

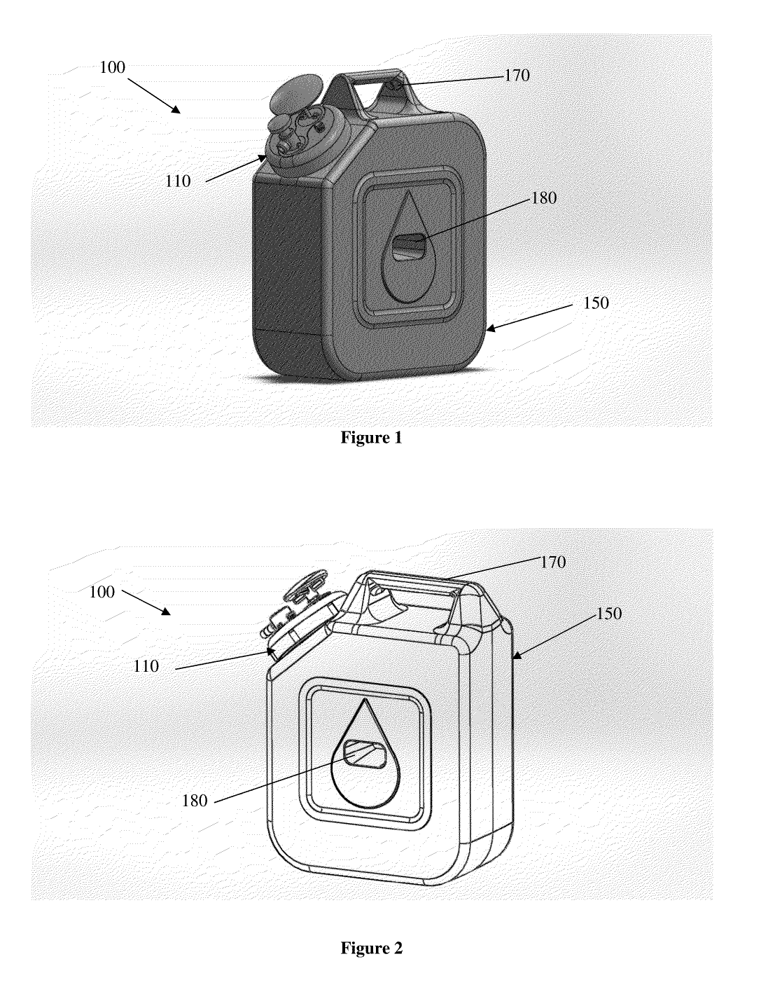

FIG. 1 shows a portable liquid delivery system 100, which includes a container 150 and a filtration system 110. Container 150 has a shape that resembles a jerrycan and is sized to hold at least several gallons of a liquid. Container 150 can be made of any material suitable for holding a liquid. Examples of materials can include, but are not limited to, stainless steel, metal alloys, plastics, polymers, ceramics, and composites. Container 150 has a handle 170, which can be used to carry or tilt container 150 for dispensing. Container 150 also has a brace member 180 that connects two of the walls of container 150 to provide strength. Brace member 180 can be circular in shape (or comprise any other suitable shape) and can even receive an axle for providing container 150 with wheels.

Those of skill in the art will appreciate that container 150 could comprise many different shapes and sizes, depending on the application and need of the user, without departing from the inventive subject matter.

FIG. 2 shows a back-perspective view of portable liquid delivery system 100.

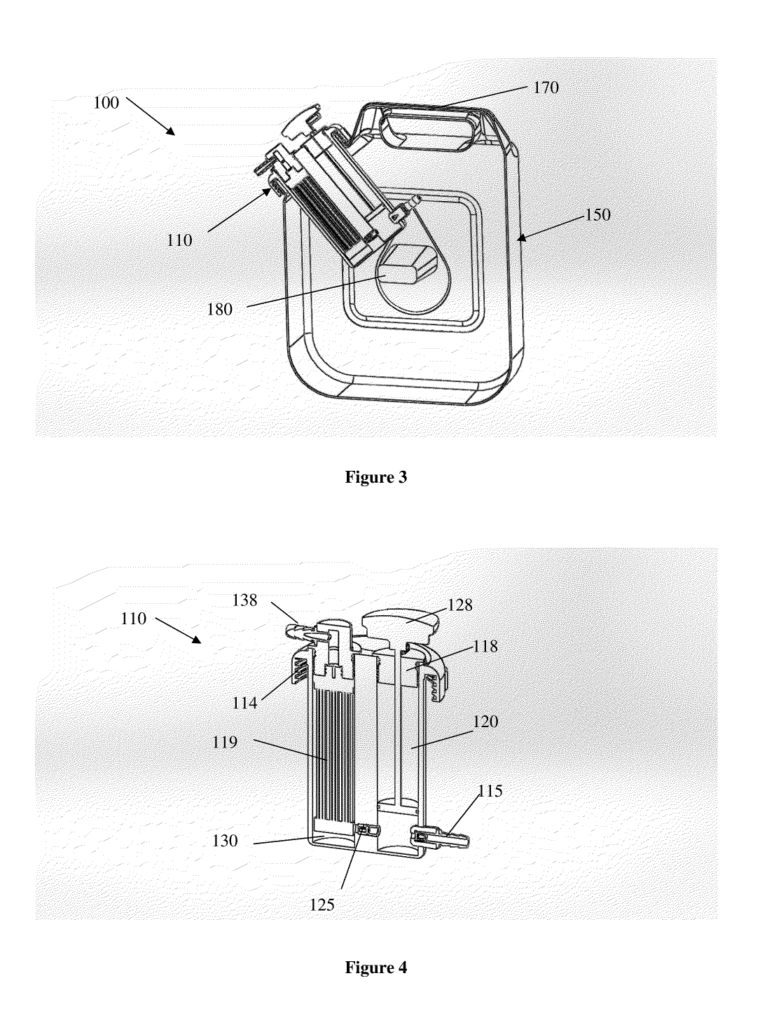

FIG. 3 shows a cross section view of portable liquid delivery system 100. Filtration system 110 is disposed at least partially in an opening of container 150 and acts as a cap for container 150. Filtration system 110 also provides a means for filtering liquid in container 150 prior to dispensing.

FIG. 4 shows a cross section view of filtration system 110, removed from container 150. Filtration system 110 comprises a first chamber 120 and a second chamber 130 fluidly coupled via a one way valve (conduit) 125. Pump 128 is partially disposed in first chamber 120 and generally comprises an elongated body that has a first end and a second end. The first end is disposed inside first chamber 120 and slidably and sealable couples with an inner surface of first chamber 120. The second end of pump 128 is disposed outside of the housing of filtration system 110. The elongated body of pump 128 is disposed in seal 118, allowing pump 128 to slide with respect to first chamber 120. In some embodiments, seal 118 is configured to provide a fluid seal and an air-tight seal, thus ensuring that first chamber 120 is sealed off from the atmospheric pressure and from the pressure of the lumen of container 150.

Second chamber 130 includes a filter 119 for filtering a liquid. Various filters are well known and filter 119 could comprise any filter suitable for removing constituents from a liquid or for otherwise improving the quality of the liquid.

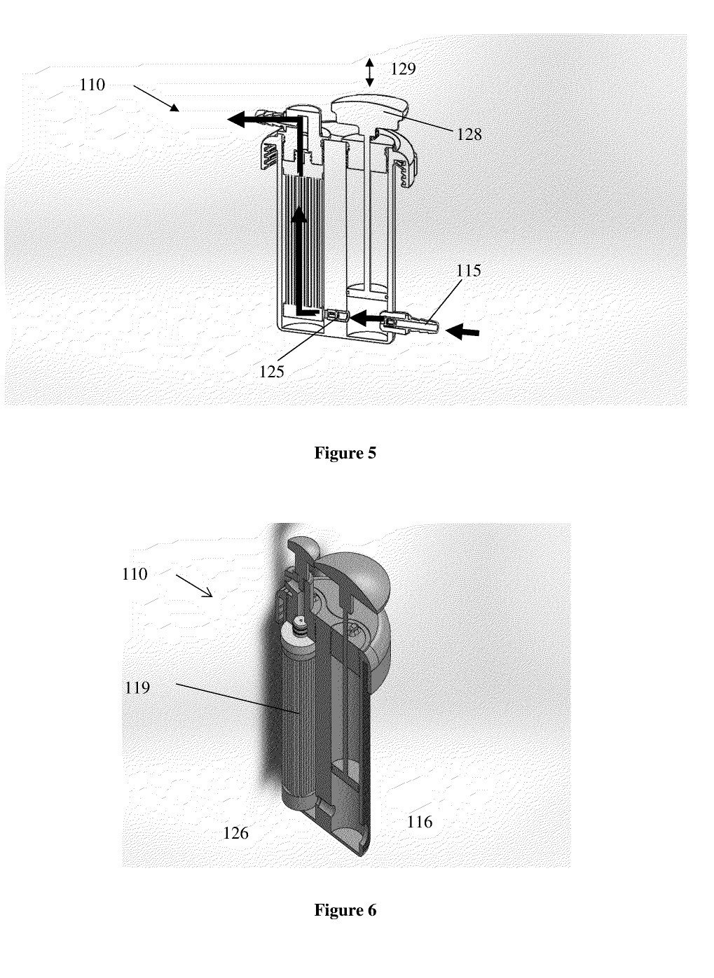

FIGS. 5 and 6 show a fluid pathway with filtration system 110 is operated. The method of operating filtration system 110 involves pulling and pushing (i.e., actuating) pump 128 in the directions shown by double arrow 129. When pump 128 is pulled upward (i.e., away from filtration system 110), a pressure deficient is created inside first chamber 120, which causes fluid to be drawn into first chamber 120 via one-way valve 115 disposed through inlet 116. When pump 128 is pushed downward (i.e., into the housing of filtration system 110), fluid is forced into second chamber 130 via one-way valve 125 disposed through conduit 126. By repeatedly actuating pump 128, liquid is pushed through filter 118 and out of outlet 138.

As shown in FIGS. 3 and 4, filtration system 110 has a flange 114 with inwardly-facing threads that mate with threads of on the opening of container 150. Filtration system 110 serves as a cap for container 150. When a user desires to fill container 150 with a liquid, filtration system 110 can be removed from container 150 to access the lumen of container 150. In alternative embodiments filtration system 110 can removably couple with container 150 via non-threaded couplings, for example, by snap fittings, pressure fittings, male-female engagements, and other removable couplings.

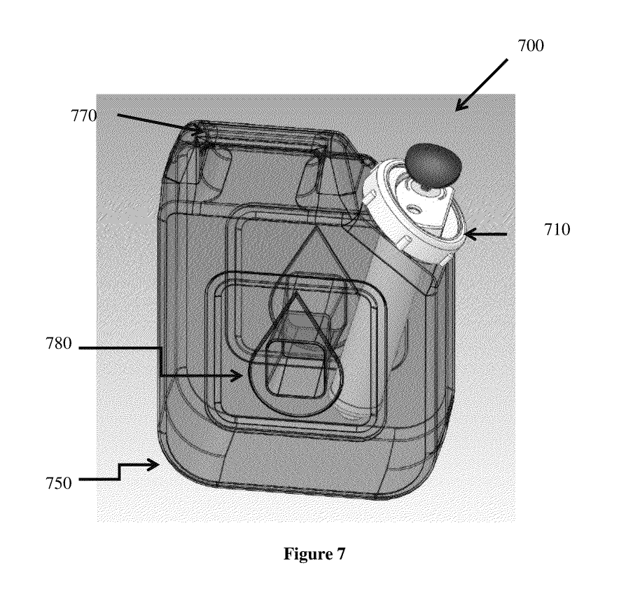

FIG. 7 shows another embodiment of a portable liquid delivery system 700, which includes a container 750 and a filter system 710. Additionally, container 750 has a handle 770, and a brace member 780. The embodiment of FIG. 7 differs slightly from portable liquid delivery system 100 in FIGS. 1-6 by the structure and layout of the filtration system 710 in some aspects, which will be described in more detail below.

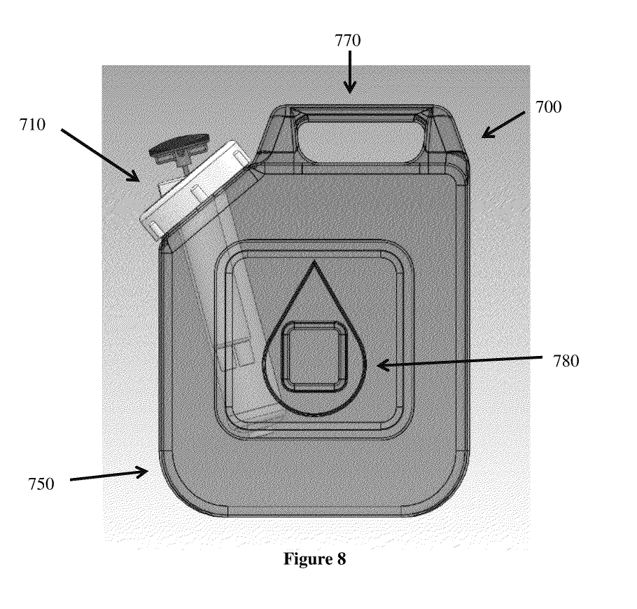

FIG. 8 shows a side-perspective cross section view of portable liquid delivery system 700. Filtration system 710 is disposed at least partially in an opening of container 750 and acts as a cap for container 750. Filtration system 710 also provides a means for filtering liquid in container 750 prior to dispensing.

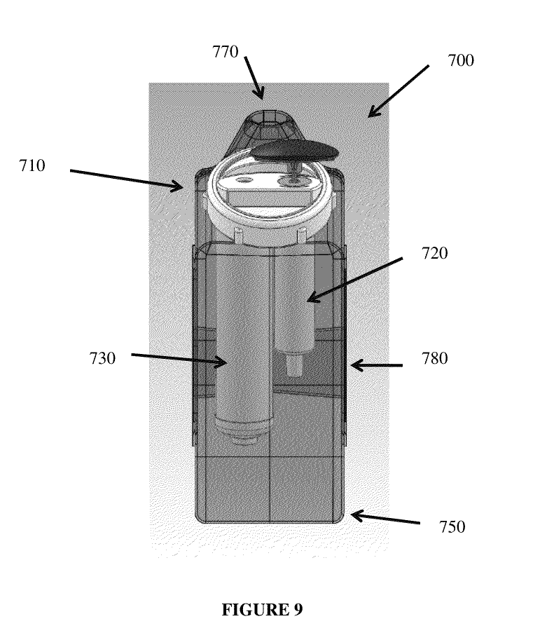

FIG. 9 shows a front-perspective cross section view of portable liquid delivery system 700. FIG. 9 more clearly shows how filtration system 710 comprises the same components as described in previous embodiments (namely two chambers, a pump, a filter, and a conduit); however, the components are not disposed within a singled housing. Instead, first chamber 720 and second chamber 730 are disposed in two cylindrical housings that are coupled at their top end. The one-way valve (e.g., conduit) connecting the chamber 720 and chamber 730 is located at the bottom end of the chambers (and outside of the chamber housings), as opposed to between the chambers (or inside the housing).

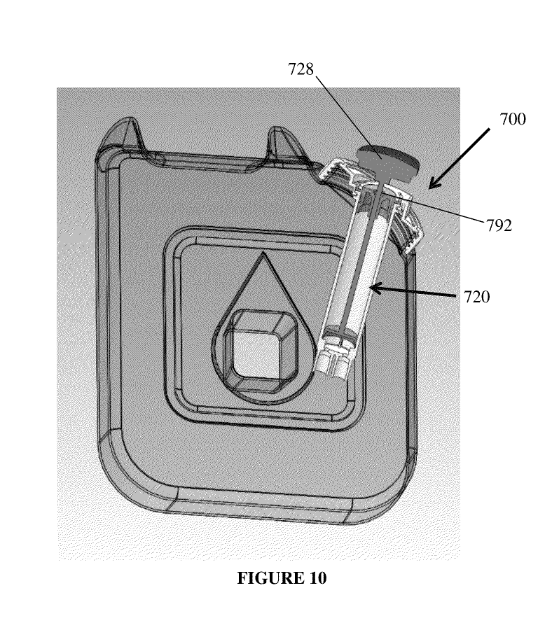

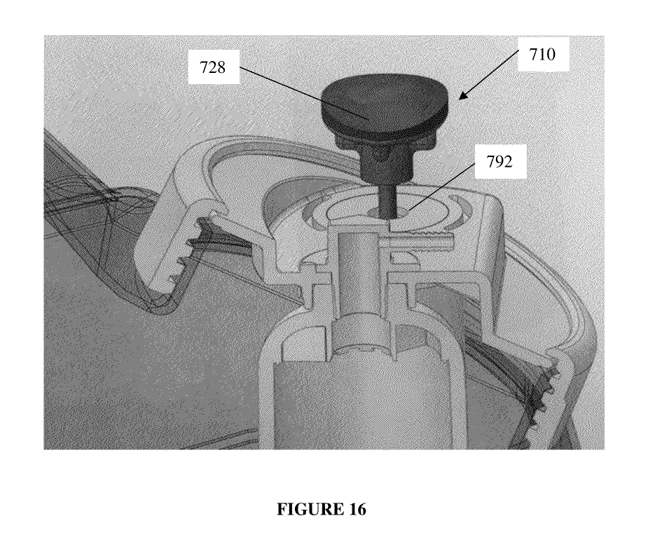

FIG. 10 shows a cross-sectional side view perspective of liquid delivery system 700 and illustrates first chamber 720 and a pump 728. Pump 728 has a first end disposed inside chamber 720 and a second end disposed outside of chamber 720. The first end slidably and sealably engages the inner surface of chamber 720. The second end is shaped as a handle for gripping. A middle section of pump 728 slidably and sealably engages an opening 792 at the top of filtration system 710 (also see FIG. 16).

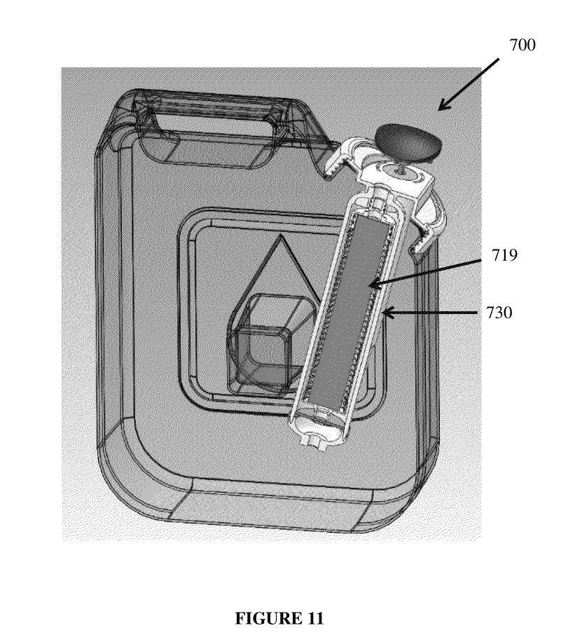

FIG. 11 shows a cross-sectional side perspective view of liquid delivery system 700 and illustrates second chamber 730 and filter 719, analogous in function to the filters described in previously described embodiments.

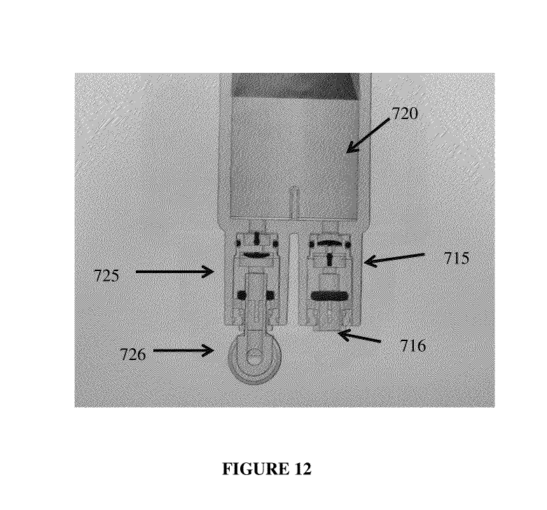

FIG. 12 shows a close-up cross section view of first chamber 720, and illustrates first one-way valve 715 and inlet 716 (for receiving liquid from the reservoir of container 750) and second one-way valve 725 and conduit 726 (for delivering the liquid to second chamber 730). As in previously described embodiments, by repeatedly actuating the pump of first chamber 720, liquid is pulled into chamber 720 via valve 715 and pushed out of chamber 720 via valve 725.

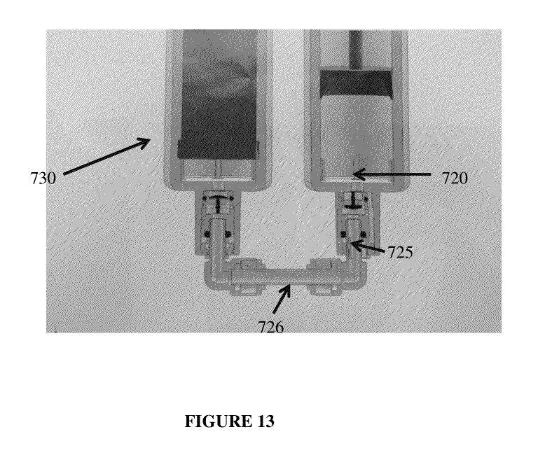

FIG. 13 shows a close up view of conduit 726 as it connects first chamber 720 to second chamber 730.

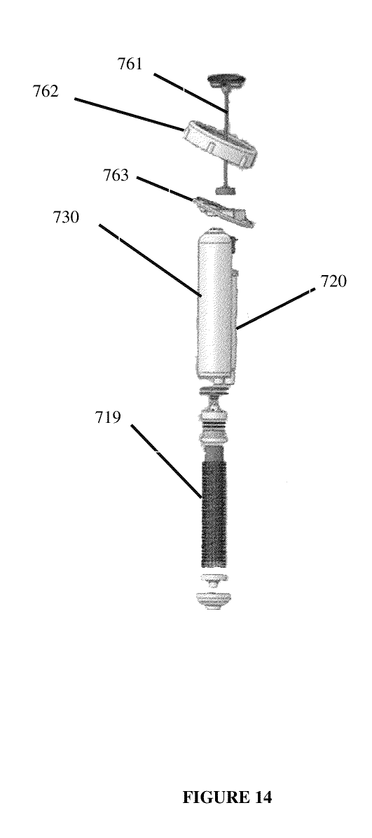

FIG. 14 shows an exploded view of filtration system 710 with filter 719 removed from chamber 730.

System 710 has a cap 762 comprising a threaded sleeve (e.g., a flange with internal threading) that mates with threads on an opening of container 750. Cap 762 also mates with face plate 763. Face plate 763 has a first opening for dispensing liquid. A spout can be coupled with the first opening of face plate 763. Face plate 763 has a second opening in which pump 761 is disposed. Pump 761 is slidably and sealably coupled with the second opening, thus allowing a user to actuate the pump to dispense liquid.

In some embodiments, face plate 763 is rigidly coupled with cap 762. When a user desires to remove filtration system 710 from container 750, the user can unthread cap 762 from container 750 by rotating cap 762 (thus rotating all of filtration system 710), as shown by arrow 787. In other embodiments, face plate 763 is removably and/or rotatably coupled with cap 762. As such, rotating cap 762 will not cause the remaining components of filtration system 710 (e.g., chambers 720 and 730) to rotate.

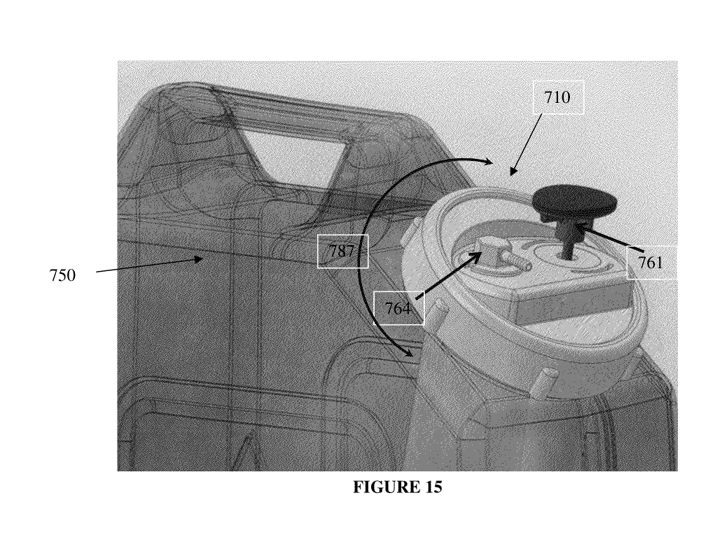

FIGS. 15 and 16 show perspective and cross sectional views, respectively, of filter system 710, and illustrate various features of cap 762, spout 764, the handle of cap 761, and face plate 763.

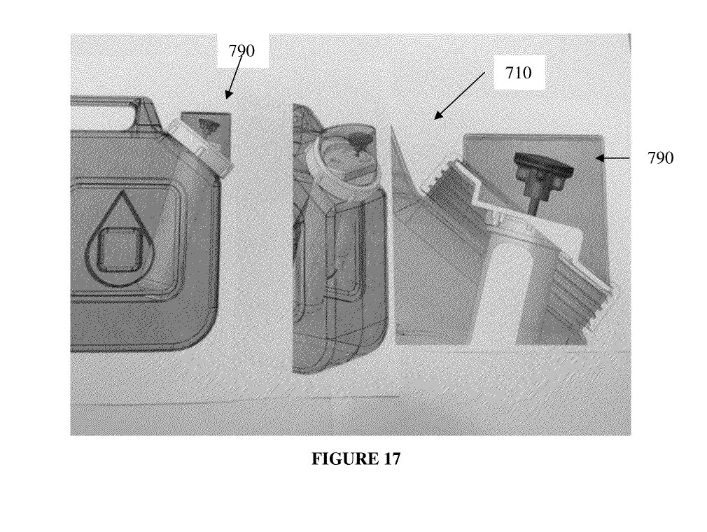

FIG. 17 shows side and perspective views of liquid delivery system 700 with protective cap 790 over face plate 763.

Those of ordinary skill in the art will appreciate that the inventive filtration systems discussed herein can be used with non-portable containers and could be used to filter liquids other than water.

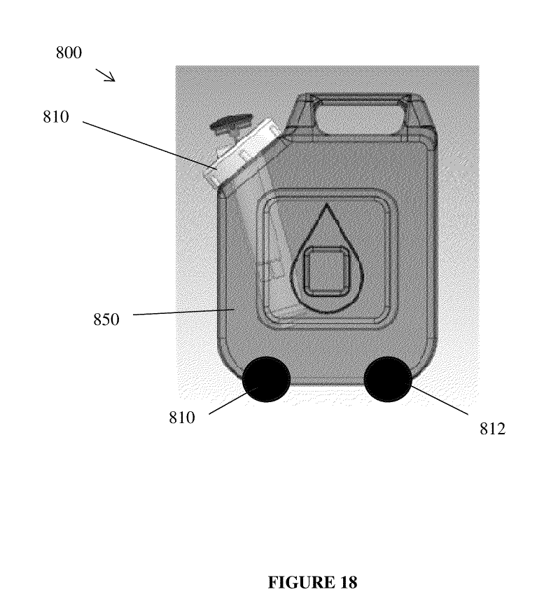

FIG. 18 shows a portable liquid delivery system 800 that has a first pair of wheels 810 and a second pair of wheels 812. Each wheel is connected with its pair via an axle running through a hollow tube brace member (similar to brace member 780 in FIG. 7) near the bottom of container 850. Wheels 810 and 812 allow system 800 to be easily moved. Wheels 810 and 812 can include locks that lock system 800 in place during use.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A filter system, comprising:
a first chamber;
a second chamber;
a conduit that fluidly couples the first and second chambers;
an inlet fluidly coupled with the first chamber;
an outlet fluidly coupled with the second chamber;
wherein the conduit includes a first one-way valve that allows a liquid to flow from the first chamber to the second chamber;
wherein the inlet includes a second one-way valve that allows a liquid to flow into the first chamber;
a pump partially disposed in the first chamber, the pump comprising:
an elongated body having a first end and a second end;
wherein the first end slidably couples with an internal surface of the first chamber in a sealing fashion;
wherein the second end is disposed outside the first chamber; and
wherein the elongated body slidably couples with a seal disposed in an opening of the first chamber; and
a filter disposed in the second chamber.

2. The filter system of claim 1, wherein the second end of the pump has a gripping surface for actuating the pump.

3. The filter system of claim 1, wherein the outlet includes a sprout suitable for dispensing the liquid.

4. The filter system of claim 1, wherein the filter is selected from the group consisting of a granular-activated carbon filter, metallic alloy filter, microporous ceramic filter, carbon block resin membrane filter, and an ultrafiltration membrane filter.

5. The filter system of claim 1, wherein the filter is configured to remove constituents having a particle size of 0.01 μm.

6. The filter system of claim 1, wherein the housing further comprises an external flange having inwardly-facing threads.

7. The filter system of claim 1, wherein the first chamber and second chamber are enclosed in a single housing.

8. The filter system of claim 7, wherein the conduit is disposed in a wall of the housing and between the first chamber and second chamber.

9. The filter system of claim 1, wherein the first chamber is disposed in a first cylindrical housing and the second chamber is disposed in a second cylindrical housing.

10. The filter system of claim 9, wherein the conduit is disposed outside the first (cylindrical) housing and second (cylindrical) housing.

11. A portable liquid delivery system comprising:
a container defining a lumen suitable for holding a liquid and having an opening; and
a filtration system disposed in the opening of the lumen and comprising:
a first chamber fluidly coupled with a second chamber via a conduit, the conduit comprising a first one-way valve that allows a liquid to flow from the first chamber to the second chamber;
wherein the first chamber has an inlet disposed in the lumen, the outlet comprising a second one-way valve that allows a liquid to flow into the first chamber;
wherein the second chamber has an outlet disposed outside the lumen;
wherein the inlet includes a second one-way valve that allows a liquid to flow into the first chamber;
an elongated member having a first end, a second end, and a middle section;
wherein the first end of the elongated member is disposed in the first chamber and is slidably coupled with an internal surface of the first chamber in a sealing fashion;
wherein the second end of the elongated member is disposed outside the first chamber; and
wherein at least a portion of the middle section of the elongated body slidably couples with a seal disposed in an opening of the first chamber; and
a filter disposed in the second chamber.

12. The portable liquid delivery system of claim 11, wherein the container further includes a handle.

13. The portable liquid delivery system of claim 11, wherein the container further comprises a brace member connecting a first wall of the container and a second wall of the container.

14. The portable liquid delivery system of claim 13, wherein the brace member comprises a hollow tube.

15. The portable liquid delivery system of claim 13, further comprising an axle disposed in the hollow tube and first and second wheels rotatably coupled with the axle.

16. The portable liquid delivery system of claim 11, wherein the lumen is sized and dimensioned to hold at least ten gallons of the liquid.

17. The portable liquid delivery system of claim 11, wherein the liquid is water.

18. The portable liquid delivery system of claim 11, wherein the opening of the container has external threads that mate with internal threads disposed on a flange of the filtration system.
